(19) United States
(12) Patent Application Publication
(10) Pub. No.: US 2023/0234777 A1
(43) Pub. Date: Jul. 27, 2023

(54) DETECTOR

(71) Applicant: Total Waste Solutions Ltd, Sheffield (GB)

(72) Inventors: Sallyanne Rogers, Sheffield (GB); Tim Hale, Sheffield (GB); Graham Bland, Sheffield (GB)

(21) Appl. No.: 18/002,358

(22) PCT Filed: Feb. 18, 2021
(86) PCT No.: PCT/GB2021/050407

§ 371 Date: Dec. 19, 2022

(30) Foreign Application Priority Data
Jun. 18, 2020 (GB) 2009300.1

(51) Int. Cl. B65F 1/14; G08B 21/22; G08B 7/06; G06V 40/10; G06V 10/82

(52) U.S. Cl. CPC B65F 1/14; G06V 10/82; G06V 40/10; G08B 7/06; G08B 21/22; B65F 2210/168

(57) ABSTRACT

A detector is configured to be mounted to a container. The detector has a housing and a mounting arrangement for mounting the housing to a container. A sensor arrangement includes a sensor to monitor the container and to generate a sensor output signal in response to a sensed container event. A processor executes a machine learning algorithm trained to determine a class of the sensed container event for determining occupancy of the container from the sensor output signal, where the control system is configured to provide an output based on the class of sensed container event determined by the machine learning algorithm.

### FIELD OF THE INVENTION

The present invention relates to a detector for determining the occupancy of a container, and to a container including a detector for determining the occupancy thereof.

### BACKGROUND OF THE INVENTION

In order to find shelter from harsh weather conditions, it is becoming an increasingly common occurrence for people to find rest in a refuse or recycling container (also known as a bin). It is possible for occupants of such a container to be severely, or sometimes even fatally, injured, e.g. if they are transferred from the container to a refuse/recycling compacting collection vehicle. In light of this, there is growing concern within the refuse/recycling collection industry about the rising number of people sleeping in such containers.

In order to reduce the risk of an occupant of a container becoming injured, it is common practice for operators (i.e. refuse/recycling collectors) to try and determine the occupancy of a container prior to emptying the recycling/refuse in the container to a collection vehicle. Traditional methods require the operator to investigate the internal space of the container, e.g. by moving waste around, shouting, making noises on the side of the bin etc. However, these methods are not always effective, e.g. if a person within a container does not wake up, or is not visible to an operator.

The present invention seeks to overcome or at least mitigate one or more problems associated with the prior art.

### SUMMARY OF THE INVENTION

A first aspect provides a detector for mounting to a container defining an internal space to determine occupancy of the container, the detector comprising: a housing; a mounting arrangement for mounting the housing to a container; a sensor arrangement mounted to the housing, the sensor arrangement comprising a sensor configured to monitor the container and to generate a sensor output signal in response to a sensed container event; and a control system comprising a processor configured to execute a machine learning algorithm trained to determine a class of the sensed container event for determining occupancy of the container from the sensor output signal, wherein the control system is configured to provide an output based on the class of sensed container event determined by the machine learning algorithm.

The machine learning algorithm is able to predict the occupancy of the container based on the output from the signal quickly and reliably by classifying the container event (e.g. waste loading/emptying, a person entering/leaving etc.). This can be particularly advantageous due to the wet, dirty and dusty environment in the container, which may affect the operation and accuracy of some types of sensors. Hence, the use of the machine learning algorithm to predict the occupancy of the container helps to improve the reliability of the detector.

Thus, the present detector helps to reduce the risk of an occupant of a container becoming injured by facilitating the determination of the occupancy of the container. The detector also enables an operator, e.g. a waste operative at the container location or remote therefrom to determine the occupancy of the container without the need to visually inspect inside the container. In instances where a person is determined to be within a container, this also enables the operator to prepare for an encounter with the individual or enables the operator to report this to a third party.

The machine learning algorithm may receive the sensor output signal from the sensor and determine a class of the sensed container event based on the sensor output signal to determine the occupancy of the container. The control system may be configured to provide an output based on the occupancy of the container determined by the machine learning algorithm.

This has been found to accurately determine the occupancy of a container based on the output signal from a sensor of a detector mounted to the container.

The control system may comprises a memory. The machine learning algorithm may be configured to compare the received sensor output signal with sensor signal data stored on the memory to classify the container event.

The machine learning algorithm may comprise a neural network.

The neural network may be capable of performing pattern recognition. The neural network may be able to determine occupancy of a container based on this pattern recognition.

The machine learning algorithm may comprise a supervised deep learning neural network.

A neural network has been found to be particularly accurate at determining the occupancy of a container based on signals from the sensor. In trials, the neural network has been found to accurately classify the occupancy with supervised deep learning.

The processor may be configured to receive an update to the machine learning algorithm.

The update may be configured to train the machine learning algorithm to determine the occupancy of a new type or size of container.

This advantageously enables the detector to be mounted to a range of different containers to accurately determine the occupancy thereof.

The update may be configured to train the machine learning algorithm to increase the accuracy of determining the occupancy of the container.

The machine learning algorithm may be trained using training data generated by a training container.

The training data may comprise a plurality of sensor output signals each generated in response to a container event sensed by the sensor, each sensor output signal having a corresponding datum indicative of the class of container event.

The machine learning algorithm may be trained using training data generated by a detector mounted to any of a container adjacent to building air vents, a container in an enclosed space, a container in an open space and a container adjacent to heavy traffic.

The class of container event may be selected from one or more of: material being loaded into a container; material being removed from a container; material within a container being depressed; movement of a container, e.g. over a surface; a person entering a container; a person leaving a container; and a person moving within a container.

The processor may be configured to communicate the determined occupancy of a container to an indicator, a display, or another device.

The detector may comprise a transmitter for transmitting a signal indicative of the determined occupancy of a container to a processor at a remote location.

This arrangement advantageously allows for the occupancy of the container, or a series of containers, to be monitored remotely.

The detector may comprise an indicator comprising a first state for indicating that a container is occupied and a second state for indicating that a container is unoccupied, and wherein the output of the control system sets the state of the indicator based on the output of the machine learning algorithm.

The indicator may comprise an audible indicator and/or a visual indicator.

This arrangement effectively alerts an operator to the occupancy state of the containers.

The control system may be configured to activate the indicator for a predetermined period of time, e.g. 10 seconds, 30 seconds, a minute, or any other suitable time period, after a sensor output signal is received by the machine learning algorithm.

This arrangement has been found to increase battery life as it does not require the indicator to constantly active. Moreover, this arrangement stop attention being drawn to the container, which helps to reduce the likelihood of a person getting into the container.

The sensor arrangement may be configured to determine an orientation of a container, in use, and wherein the control system is configured to change the indicator from the first state to the second state upon rotation of a container by at least a predetermined angle. The predetermined angle may be approximately 90 degrees.

This arrangement enables the detector, i.e. via the control system, to automatically reset the indicator during the process an emptying the container (i.e. during a discharge of the contents of the container) without the need for operator interference.

The sensor may comprise an accelerometer or a gyroscope configured to detect container events in the form of container vibrations.

The use of an accelerometer has been found to provide accurate readings as to when an action is being carried out on the container and is able to detect a person getting into or out of a container. The use of this sensor arrangement with the machine learning algorithm has been found to improve the accuracy and reliability of the occupancy determination of a container.

The sensor may be configured to detect container events in the form of movement within a container. The sensor may comprise an ultrasonic sensor and/or an infrared sensor and/or a camera.

The use of a motion detector has been found to provide accurate readings as to when an action is being carried out within the container and is able to detect a person moving around in a container. The use of this sensor arrangement with the machine learning algorithm has been found to improve the accuracy and reliability of the occupancy determination of a container.

The detector may comprise a power storage unit disposed within the housing configured to provide power to the sensor arrangement.

The power storage unit may be mounted to the housing via an anti-vibration mounting arrangement.

This arrangement works to dampen the shock/impact imparted from the container to the power storage unit (e.g. batteries).

The mounting arrangement may comprise a dampening mounting arrangement.

The mounting arrangement may comprise one or more fasteners in the form of dampening members.

The housing may be sealed so as to prevent the ingress of dust, moisture or debris. The sensor may be disposed within the sealed housing.

The housing is substantially sealed to prevent dust ingress into the housing that could damage the internal components of the detector.

The mounting arrangement may comprise at least one fastener configured and arranged to extend through an outer wall of a container, in use, in order to mount the detector to the container.

The mounting arrangement may comprise a mounting plate for positioning within a container such that a section of a container is positioned between the mounting plate and the housing, in use.

The sensor arrangement may comprise a temperature sensor configured to detect the temperature within a container, and wherein, when the temperature within the container exceeds a pre-determined value an output from the temperature sensor is compared with the output from the machine learning algorithm.

The temperature sensor may be configured to detect temperature outside of a container, and wherein, when the difference between the temperature inside a container and the temperature outside of a container exceeds a pre-determined value an output from the temperature sensor is compared with the output from the machine learning algorithm.

Monitoring the temperature within a container further aids in the detection of occupancy of the container. Should the temperature within a container rise above a predetermined value, this may be caused by an occupant within the container, and so the control system alerts an operator.

Monitoring the relative temperature inside and outside of the container increases the reliability of the determination of the occupancy of the container. This comparative temperature monitoring enables the control system to be used in different climates, or over different seasons, without requiring any reconfiguration.

The sensor arrangement may comprise a humidity sensor configured to monitor humidity within a container, and wherein, when the humidity within a container exceeds a predetermined value, an output from the humidity sensor is compared with the output from the machine learning algorithm.

Monitoring humidity within the container further increases the reliability of the determination of the occupancy of the container, as the raised humidity may be the result of an occupant’s breathing.

The sensor arrangement may comprise a further sensor configured to determine a concentration of carbon dioxide and/or volatile organic compounds within the internal space of the container, and wherein, when the concentration of carbon dioxide and/or volatile organic compounds exceeds a predetermined value, an output from the further sensor is compared with the output from the machine learning algorithm.

This arrangement helps to further improve the accuracy of the occupancy determination for a container.

The sensor may be configured to detect a heartbeat of a person within the container and generate a sensor output signal in response to a detected heartbeat.

The sensor may be a cardioballistic sensor.

The detector may comprise a fire suppressant device located within the housing.

The sensor may be configured to detect vital signs of a person within the container and to generate a sensor output signal in response to detected vital signs.

The control system may be configured to receive the sensor output signal and to provide an output based on the sensor output signal.

The container may include a body defining an internal/enclosed space, the container may comprise a lid or door that openable to enable a person to enter/leave the container.

A second aspect provides a container having a detector according to the first aspect mounted thereto.

A third aspect provides for a container comprising: a body defining an internal space; and a detector mounted to the body and configured to determine the occupancy of the container, wherein the detector comprises a housing, a mounting arrangement for mounting the housing to a container, a sensor arrangement mounted to the housing, the sensor arrangement comprising a sensor configured to monitor the container and to generate a sensor output signal in response to a sensed container event, and a control system comprising a processor configured to execute a machine learning algorithm trained to determine a class of the sensed container event for determining occupancy of the container from the sensor output signal, wherein the control system is configured to provide an output based on the class of sensed container event determined by the machine learning algorithm.

The container may be a refuse container, a recycling container, a shipping container, or a trailer of a road vehicle.

A fourth aspect provides a method of determining the occupancy of the container of the second aspect or the third aspect, the method comprising: monitoring the container with the sensor; generating a sensor output signal in response to a sensed container event; using a machine learning algorithm to determine a class of the sensed container event in order to determine the occupancy of the container; and providing an output based on the occupancy of the container determined by the machine learning algorithm.

A fifth aspect provides for a method of generating training data for supervised machine learning, the method comprising: mounting a detector according to the first aspect to a training container; and generating training data by: sensing a container event with the sensor so as to generate a sensor output signal; and inputting into the control system the class of container event corresponding to the sensor output signal.

The processor may be configured to generate training data by: receiving one or more sensor output signals from the sensor; and receiving the class of container action corresponding to the or each sensor output signal.

A sixth aspect provides for a computer-readable medium comprising training data generated according to the method of the fifth aspect.

A seventh aspect provides for a computer-implemented method of training a machine learning algorithm to determine occupancy of a container based on sensor output signals from a sensor of a detector mounted to a container, the method comprising: providing training data comprising: a plurality of sensor output signals each generated from the sensor sensing a container event, each sensor output signal having a corresponding datum indicative of the class of container event; and using the training data in order to train the machine learning algorithm to recognise the class of container event from a sensor output signal without a corresponding datum indicative of the class of container event so as to determine the occupancy of the container.

An eighth aspect provides for a detector for mounting to a container defining an internal space to determine occupancy of the container, the detector comprising: a sealed housing; a mounting arrangement for mounting the housing to a container; and a sensor arrangement mounted within the housing, the sensor arrangement comprising a sensor configured to monitor the container and to generate a sensor output signal in response to a sensed container event, wherein the sensor is configured to detect a heartbeat of a person within the container and generate a sensor output signal in response to a detected heartbeat, and wherein the control system is configured to receive the sensor output signal and to provide an output based on the sensor output signal.

The sensor may be a cardioballistic sensor.

The detector may comprise a power storage unit disposed within the housing configured to provide power to the sensor arrangement. The power storage unit may be mounted to the housing via an anti-vibration mounting arrangement.

The mounting arrangement may comprise at least one fastener configured and arranged to extend through an outer wall of a container, in use, in order to mount the detector to the container.

The mounting arrangement may comprise a mounting plate for positioning within a container such that a section of a container is positioned between the mounting plate and the housing, in use.

The control system may be configured to communicate the determined occupancy of a container to an indicator, a display, or another device.

The detector may comprise an indicator comprising a first state for indicating that a container is occupied and a second state for indicating that a container is unoccupied, and wherein the output of the control system sets the state of the indicator based on the sensor output signal. The indicator may comprise an audible indicator and/or a visual indicator.

The control system may be configured to activate the indicator for a predetermined period of time, e.g. 10 seconds, 30 seconds, a minute, or any other suitable time period, after a sensor output signal is received by the control system.

The sensor arrangement may be configured to determine an orientation of a container, in use, and wherein the control system is configured to change the indicator from the first state to the second state upon rotation of a container by at least a predetermined angle. The predetermined angle may be approximately 90 degrees.

A ninth aspect provides for a detector for mounting to a container defining an internal space to determine occupancy of the container, the detector comprising: a sealed housing; a mounting arrangement for mounting the housing to a container; and a sensor arrangement mounted within the housing, the sensor arrangement comprising a sensor configured to monitor the container and to generate a sensor output signal in response to a sensed container event, wherein the sensor is configured to detect vital signs of a person within the container and to generate a sensor output signal in response to detected vital signs, and wherein the control system is configured to receive the sensor output signal and to provide an output based on the sensor output signal.

The detector may comprise a power storage unit disposed within the housing configured to provide power to the sensor arrangement. The power storage unit may be mounted to the housing via an anti-vibration mounting arrangement.

The mounting arrangement may comprise at least one fastener configured and arranged to extend through an outer wall of a container, in use, in order to mount the detector to the container.

The mounting arrangement may comprise a mounting plate for positioning within a container such that a section of a container is positioned between the mounting plate and the housing, in use.

The control system may be configured to communicate the determined occupancy of a container to an indicator, a display, or another device.

The detector may comprise an indicator comprising a first state for indicating that a container is occupied and a second state for indicating that a container is unoccupied, and wherein the output of the control system sets the state of the indicator based on the sensor output signal. The indicator may comprise an audible indicator and/or a visual indicator.

The control system may be configured to activate the indicator for a predetermined period of time, e.g. 10 seconds, 30 seconds, a minute, or any other suitable time period, after a sensor output signal is received by the control system.

The sensor arrangement may be configured to determine an orientation of a container, in use, and wherein the control system is configured to change the indicator from the first state to the second state upon rotation of a container by at least a predetermined angle. The predetermined angle may be approximately 90 degrees.

A tenth aspect provides for a detector for mounting to a container defining an internal space to determine occupancy of the container, the detector comprising: a sealed housing; a mounting arrangement for mounting the housing to a container; and a sensor arrangement mounted within the housing, the sensor arrangement comprising a sensor configured to monitor the container and to generate a sensor output signal in response to a sensed container event, wherein the sensor configured to detect the temperature within a container, and wherein, when the temperature within the container exceeds a pre-determined value, the sensor generates a sensor output signal, and wherein the control system is configured to receive the sensor output signal and to provide an output based on the sensor output signal.

The temperature sensor may be configured to detect temperature outside of a container, and wherein, when the difference between the temperature inside a container and the temperature outside of a container exceeds a pre-determined value, the sensor generates a sensor output signal.

The detector may comprise a power storage unit disposed within the housing configured to provide power to the sensor arrangement. The power storage unit may be mounted to the housing via an anti-vibration mounting arrangement.

The mounting arrangement may comprise at least one fastener configured and arranged to extend through an outer wall of a container, in use, in order to mount the detector to the container.

The mounting arrangement may comprise a mounting plate for positioning within a container such that a section of a container is positioned between the mounting plate and the housing, in use.

The control system may be configured to communicate the determined occupancy of a container to an indicator, a display, or another device.

The detector may comprise an indicator comprising a first state for indicating that a container is occupied and a second state for indicating that a container is unoccupied, and wherein the output of the control system sets the state of the indicator based on the sensor output signal. The indicator may comprise an audible indicator and/or a visual indicator.

The control system may be configured to activate the indicator for a predetermined period of time, e.g. 10 seconds, 30 seconds, a minute, or any other suitable time period, after a sensor output signal is received by the control system.

The sensor arrangement may be configured to determine an orientation of a container, in use, and wherein the control system is configured to change the indicator from the first state to the second state upon rotation of a container by at least a predetermined angle. The predetermined angle may be approximately 90 degrees.

### BRIEF DESCRIPTION OF THE DRAWINGS

Embodiments of the invention will now be described with reference to the accompanying drawings, in which:

FIG. 1 is a schematic view of a container including a detector according to an embodiment mounted to the container;

FIG. 2 is a partial schematic side view of the detector of FIG. 1 mounted to the container.

FIG. 3 is a rear perspective view of the detector of FIG. 1;

FIG. 4 is an exploded view of the detector of FIG. 1;

FIG. 5 shows the machine learning system; and

FIG. 6 shows the machine learning process carried out by the processor of the machine learning system in FIG. 5.

### DETAILED DESCRIPTION OF EMBODIMENT(S)

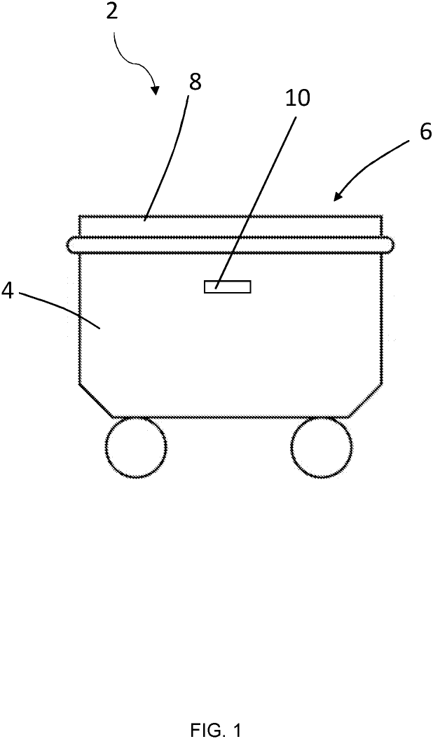

Referring to FIG. 1, a detector 10 is illustrated mounted to a container 2. The container 2 includes a body 4 defining an internal/enclosed space 6 and a lid 8 for opening and closing the container 2. The detector 10 is mounted to an external surface of the container 2 so as to be visible from the outside of the container 2. The detector 10 is configured to determine the occupancy within the container 2 (i.e. the detector 10 is configured to determine whether one or more people are in the container 2).

The detector 10 is mounted to one of the side walls of the body 4 of the container 2. The detector 10 is illustrated as being positioned a distance approximately a third of the height of the container 2, and substantially central on a side wall of the body 4. It will be appreciated that the detector 10 may be positioned at any suitable location on the container 2, such as on any part of the body 4 or lid 8.

In the illustrated embodiment, the container 2 is shown as being an industrial refuse or recycling container. The container body 4 includes four side walls and a base to define an open topped body 4. The lid 8 is positioned so as to close the open topped body 4. In alternative arrangements, it will be appreciated that the detector 10 may be mounted onto any suitable container into order to determine the occupancy thereof, such as a shipping container or a trailer of a road vehicle.

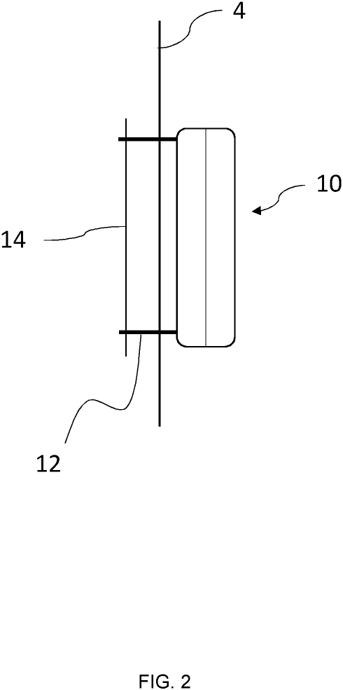

As illustrated in FIG. 2, a mounting arrangement is provided to secure the detector 10 to the container 2. The detector 10 is configured to be mounted to an external wall of a container 2. This improves visibility of the detector 10, which enables an operator to quickly determine that a detector 10 has been fitted to the container 2, and also to determine the occupancy of the container 2. Thus, the detector 10 enables an operator (such as a waste operative at the location of the container 2 or an operator that is monitoring occupancy of the container 2 remotely, e.g. an end user of a computer program or an application on a mobile telephone) to determine the occupancy of the container 2 without visual inspection.

The mounting arrangement includes fasteners 12 extending through a side wall 4 of the container 2 to mount the detector 10 to the container 2. In the illustrated arrangement, four fasteners 12 are provided to mount the detector 10 to the container 2.

The mounting arrangement includes a mounting plate 14 positioned within the container 2. The mounting plate 14 includes a series of apertures therein to receive the fasteners 12 therein, so as to secure the mounting plate 14 to the detector 10. As such, a section of the container 2 is positioned between the mounting plate 14 and the detector 10. It will be appreciated that in some arrangements, the mounting plate 14 may be omitted.

In order to dampen any force transmitted between the container 2 and the detector 10 (e.g. when opening and closing the lid, moving the container 2 and/or loading/emptying the container 2), the mounting arrangement includes a dampening (e.g. vibration reducing) mounting arrangement. Put another way, the mounting arrangement is configured to reduce the shock/impact imparted to the detector 10 from the container 2. In the illustrated embodiment, the dampening arrangement includes dampening members provided as DIN 125A shock absorbing washers. It will be appreciated that any suitable arrangement for dampening forces imparted onto the detector 10 from the container 2 may be used. In alternative arrangements, it will be appreciated that the mounting arrangement may not include a dampening mounting arrangement.

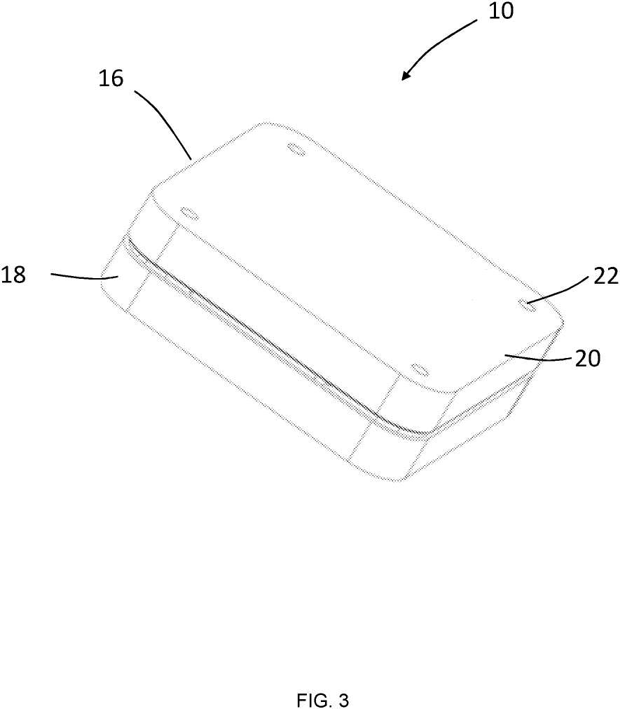

Referring now to FIG. 3, the detector 10 includes a housing 16 defining an internal volume. The housing 16 includes a first housing part 18 releasably secured to a second housing part 20 to define the internal volume. In the present arrangement the first and second housing parts 18, 20 are of substantially the same shape, both having a generally rectangular open-topped box structure. In alternative embodiments, it will be appreciated that the first and second housing parts 18, 20 may have any suitable shape suitable for forming an internal housing volume. In one exemplary arrangement, the first and second housing parts 18, 20 have a circular cross-sectional shape, and in another the first housing part 18 may be provided as an open top box structure and the second housing part 20 may be provided as a plate.

The first and second housing parts 18, 20 are releasably secured together via four fasteners (not shown). Each fastener extends through openings in both the first housing part 18 and the second housing part 20. The openings for the fasteners are located in the each of the four corners of the housing parts 18, 20, but it will be appreciated that any suitable number of fasteners and locations may be used.

The second housing part 20 includes bores 22 for receiving the fasteners 12 therein for securing the detector 10 to a container 2. In the arrangement shown, the second housing part 20 includes four bores 22 (one bore 22 proximate each corner of the second housing part 20), but any suitable number may be used. It will be understood that the fastener 21 may mount the detector 10 to the container 2 as well as securing the first and second housing parts 18, 20 together, or that separate fasteners may be provided.

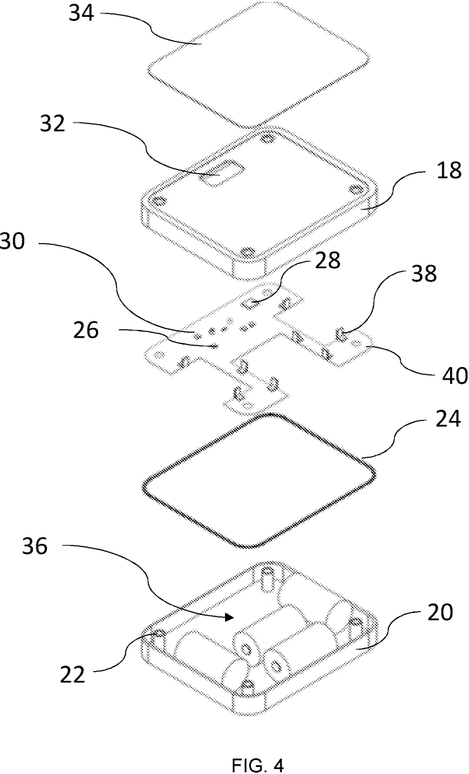

Referring now to FIG. 4, the internal parts of the detector 10 are illustrated.

The internal volume of the housing 16 is sealed so as to prevent ingress of dust and/or water. A gasket 24 is provided between the first and second housing parts 18, 20 to provide a seal therebetween. The gasket 24 helps to ensure that the housing 16 is sealed (i.e. entirely sealed). It will be appreciated that the housing 16 may be sealed so as to produce a dust-tight IP65 rated sealed housing 16.

The detector 10 includes a sensor arrangement disposed within the housing 16. The sensor arrangement includes a sensor 26 configured to monitor the container 2 and to generate a sensor signal in response to a sensed container event.

The detector 10 is provided with a control system configured to receive the sensor signal generated by the sensor 26. The control system comprises a processor 28 configured to execute a machine learning algorithm trained to determine the class of the sensed container event. A circuit board 40 is located within the housing 16. The sensor 26 and the processor 28 are mounted to the circuit board 40.

The control system is configured to provide an output based on the class of sensed container event determined by the machine learning algorithm. It will be understood that a sensed container event may be any activity related to the container 2. These events may be divided into different classes of container events, such as one or more of: loading of material into the container 2; loading of different types, e.g. lighter mixed recycling, general waste bags, or heavy objects, of material into the container 2; removal of material from the container 2; rotation of the container 2, e.g. when emptying material from the container 2 into a waste vehicle (not shown); opening of the lid 8 of the container 2; closing of the lid 8 of the container 2; movement of material within the container 2; compressing/depressing of material within the container 2; movement of the container 2 over a surface, e.g. a road, pathway or field; an object impacting the container 2; a person getting into the container 2; a person moving within the container 2; a person sitting down within the container 2; a person getting out of a container 2; or any other suitable action that may be carried out on, in or to the container 2.

The detector 10 also includes one or more indicators configured to alert an operator. An indicator 30 is provided to alert an operator regarding the occupancy of the container 2 in response to the output of the control system. The indicator 30 is contained within the housing 16. It will be understood that the detector 10 may also include one or more additional indicators to alert an operator to a fault with the detector 10, or to alert an operator to the detector 10 being low on power.

In the present embodiment, the indicator 30 is a visual indicator provided as a light (e.g. an LED) where the colour indicated the occupancy of the container 2. When it is determined that a person has entered the container 2, the indicator 30 is changed to an active state (e.g. to a colour, intensity, flashing pattern etc). Should the person leave the container 2, it will be appreciated that the indicator 30 may remain in the active state until it is deactivated, as is discussed in more detail below. This helps to make an operator aware that the container 2 has been occupied since it was last emptied.

In alternative arrangements, tit will be appreciated that the indicator 30 (and the further indicators) may include an audible indicator and/or a visual indicator.

The indicator 30 is visible from outside of the housing 16 via a cut-out or aperture 32 in the first housing part 18. This helps to maintain visibility of the indicator 30. The detector 10 includes a transparent or translucent cover 34 secured to the first housing part 18 to maintain the sealed housing 16. The cover 34 is secured to an external face of the first housing part 18. The cover 34 also works to substantially seal the housing 112 to prevent the ingress of water and/or debris through the cut-out 32.

In order to provide the detector 10 with power (e.g. to power to the sensor 26 and indicator 30), the detector 10 includes a power storage unit 36 disposed within the housing 16. The enables the detector 10 to be a self-contained unit, without the need for connection to an external power source.

The power storage unit 36 includes four batteries located within the internal volume defined by the housing 16. Each of the batteries is mounted to the housing 16 via an anti-vibration mounting arrangement. The anti-vibration mounting arrangement is provided in the form of a mounting bracket, for example in the form of a mounting clip 38, secured to the housing 16 via one or more shock absorbing washers (not shown). This arrangement works to dampen the shock/impact imparted from the container 2 to the power storage unit 36. It will be appreciated that the number of batteries provided will vary to suit the application. Although not illustrated, the detector may be provided with a solar panel. The solar panel by be arranged to provide power directly to the detector 10 and/or to recharge the batteries of the power storage unit 36.

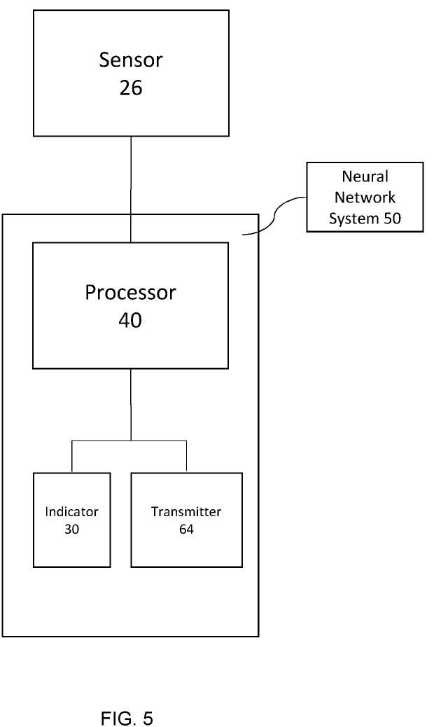

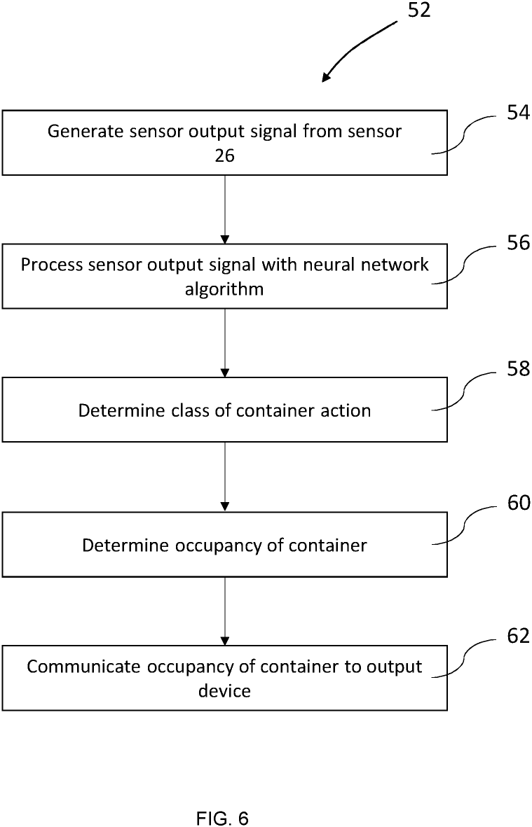

Referring now to FIGS. 5 and 6, the control system will be discussed. As discussed above, the sensor arrangement includes a sensor 26 configured to monitor the container 2 and to generate a sensor signal in response to a sensed container event. The control system comprises a processor 28 configured to execute a machine learning algorithm trained to determine the class of the sensed container event.

FIG. 5 illustrates the neural network system 50 in more detail. The neural network system 50 includes the processor 28 which receives sensor output signals from the sensor 26. The processor 40 executes a neural network process 52, shown in more detail in FIG. 6.

FIG. 6 illustrates the neural network process 52 which is carried out by processor 28 in the neutral network system 50. A sensor output signal is generated by the sensor 26 when a container event is sensed at step 54. At step 56, the sensor output signal is received and processed by a neural network algorithm that has previously been trained to determine the class of a container event from output signals from the sensor 26. The neural network algorithm determines the class of container action at step 58. The neural network algorithm outputs the determined container occupancy at step 60 and, at step 62, the container occupancy is communicated to an output device (such as the indicator 30, a display (not shown), the memory 42, and/or transmitted to a further processor at a remote location).

The container occupancy (i.e. whether the container is occupied or has been occupied, or whether the container has not been occupied) is indicated via the indicator 30, which is visible from the outside of the container 2 so as to be capable of alerting an operator. The indicator 30 has a first state indicating that a container is occupied and a second state indicating that a container is unoccupied. The output of the control system changes the state of the indicator 30 based on the output of the machine learning algorithm.

In the present arrangement, the control system is configured to activate the indicator 30 for a predetermined period of time, e.g. 10 seconds, 30 seconds, a minute, or any other suitable time period, after a sensor output signal is received by the machine learning algorithm. Put another way, in response to a sensor output signal being received by the machine learning algorithm, the control system actives the indicator 30 (e.g. lights up the indicator, or creates a sound) for a predetermined amount of time. This arrangement helps to increase the energy efficiency of the detector 10.

The occupancy of the container 2 may also be stored on memory 42 (i.e. a storage device) for later use or record keeping. The occupancy of the container 2 may be transmitted via a transmitter 64 to another device, such as a computer or mobile telephone, at a remote location, to indicate the occupancy of a container to an operator remotely. This arrangement advantageously allows for the occupancy of the container 2, or a series of containers, to be monitored remotely.

In order for the neural network to be able to accurately determine the class of container event, and so the occupancy of the container 2, using only the sensor output signal from the sensor 26, it is necessary to find an efficient way to train the neural network with sufficient training data. The training data needs to include sensor output signals where the class of container event and the occupancy of the container 2 is known. Such training data can then be used to perform supervised machine learning of the neural network. In this way, the machine learning algorithm, i.e. the neural network 50, is configured to compare the received first sensor signal with sensor signal data stored on the memory 42 to classify the container event. Thus, the neural network 50 is capable of performing pattern recognition, and determines the occupancy of the container 2 based on this pattern recognition, optionally wherein the machine learning algorithm comprises a supervised deep learning neural network.

For the neural network to accurately determine the class of container event, and so the occupancy of the container 2, it is important that the neural network has been trained using training data that was generated on the same type of container 2. Thus, the neural network has been trained on a training container that is substantially the same, e.g. of the same size and shape, as the container 2.

To improve the chance that, once trained, the neural network will be able to accurately determine the occupancy of a container 2 based solely on sensor output signals from the sensor 26, without the need for additional sensors or manual confirmation, the detector 10 on the training container is located in the same position as the detector 10 mounted on the container 2.

It is desirable to train the neural network over a wide range of different container events that may occur on/to/in a container 2, and to perform each of these different container events under a wide range of different conditions. It will be understood that the training of the detector 10 included training in a range of different locations such as adjacent to building air vents, in enclosed spaces, in open spaces, adjacent to heavy traffic and other suitable locations. Additionally, it will be understood that the training was performed under a range of different weather conditions and temperatures. This is important in order to generate training data that provides adequate training for the neural network to be able to accurately determine the occupancy of the container.

For each container event while training the detector 10, the sensor 26 generates a sensor output signal. Each sensor output signal is received by processor 28. The processor 28 also receives information regarding the class of container event and the occupancy of the training container associated with each container event. The information regarding the class of container event and the occupancy of the training container may be manually input. Each sensor output signal is stored in a storage device together of a training computer with the corresponding class of container event and the container occupancy, to build up a comprehensive set of training data.

The training data is stored on the storage device before the training data is transferred to the memory 42 of a detector 10. Transfer of the training data to the neural network 50 of the detector 10 may either involve removing the storage device from the training computer or connecting a removable storage device, for example, a USB interface to which a portable hard disk or memory stick may be connected, to a socket of the training computer and transferring the training data to the removable storage device. Alternatively the training computer may have a communications interface, which transmits the training data over a wired or wireless communications network, whether directly to a neural network training computer or to a server.

The training data provides a set of inputs (sensor output signals from the sensor 26) each paired with an expected output (the class of container event and the occupancy of the container) which makes the training data suitable for supervised machine learning of the neural network. The processor 28 runs a supervised machine learning algorithm to train the neural network so that the neural network can make accurate predictions of the occupancy of the container 2 from new sensor output signals from the sensor 26 for which the neural network has not previously been trained.

The trained neural network algorithm may be transferred to the detector 10. The trained neural network algorithm may be transferred to the neural network system 50 to train the neural network for the first time, or to update the neural network (for example, to allow the neural network to recognise occupancy of a new type of container).

In some arrangements, the sensor 26 may be configured to monitor movement of the container 2 (i.e. the container events may be movement of the container 2). The sensor 26 may be an accelerometer or a gyroscope configured to detect container events in the form of vibrations of the container 2.

In such arrangements, the sensor 26 may also be configured to determine an orientation of the container 2. The control system may be configured to change the indicator 30 from the first (i.e. active) state to the second (i.e. inactive) state upon rotation of the container 2 by at least a predetermined angle. Such a predetermined angle may be approximately 90 degrees, which would be indicative that the container 2 had been emptied.

The sensor 26 may be configured to detect container events in the form of movement within the container 2. The sensor 26 may be provided in the form of an ultrasonic sensor and/or an infrared sensor and/or a camera to detect movement within the container. In such arrangements, the sensor arrangement may still be configured to determine an orientation of a container as described above, for example by incorporating an additional gyroscope.

It will be appreciated that the sensor 26 may be configured to monitor movement of the container and to monitor movement within the container. Put another way, the sensor 26 may include a gyroscope or accelerometer for monitoring movement of the container and also an ultrasonic sensor and/or an infrared sensor and/or a camera to detect movement within the container. In such arrangements, the neural network 50 may be trained for both sensors. In further alternative arrangements, it will be appreciated that any other suitable sensor arrangement may be used in combination with the neural network 50 described, so as to determine the occupancy of the container 2.

The sensor arrangement may include a further sensor configured to detect the humidity within the container 2. In such arrangements, when the level of humidity within the container 2 exceeds a predetermined value, the output from the humidity sensor may then be compared with the output from the machine learning algorithm to improve the accuracy of occupancy determination for the container 2.

The sensor arrangement may include a temperature sensor configured to detect the temperature within the container 2. In such arrangements, when the temperature within the container 2 exceeds a predetermined value, the output from the temperature sensor may then be compared with the output from the machine learning algorithm to improve the accuracy of occupancy determination for the container 2.

The sensor arrangement may also include a further sensor configured to detect the temperature outside of the container 2. In such arrangements, when the difference between the temperature inside and outside of the container 2 exceeds a predetermined value, the outputs from the temperature sensors may then be compared with the output from the machine learning algorithm to improve the accuracy of occupancy determination for the container 2.

In arrangements incorporating a humidity sensor and/or a temperature sensor, the control system may be configured to calculate the average values of temperature and/or humidity over a pre-determined period of time. This would enable the control system to determine a mean value for each over a given time period. Put another way, the processor 40 may be configured to store input values received from the temperature and/or humidity sensor(s) and store these input values in the memory. The readings may be continuously taken and stored, and so the average/mean value continuously updated.

Significant variations the calculated average values may cause the control system to provide an output. These calculated average values help to increase the accuracy of the occupancy determination, and the control system is able to determine base average values for a particular location/time of year. Through this determination of the average or mean values for each of the monitored variables, the detector is able to determine the occupancy of a container 2 based on the base values for a given location of a container 2. This helps to increase the accuracy of the occupancy detection for a container 2.

The sensor arrangement may include a further sensor configured to detect a heartbeat of a person within the container 2. The further sensor may be a cardioballistic sensor. In such arrangements, when a heartbeat is detected within the container 2, the output from the sensor may then be compared with the output from the machine learning algorithm to improve the accuracy of occupancy determination for the container 2. The sensor may also be configured to detect other vital signs of a person within the container 2, such as respiration and/or weight and/or the temperature of the person.

It will be appreciated that in arrangements of the detector 10 incorporating two or more of the sensors discussed, the control system may be configured to only provide an output when multiple sensors, e.g. all of the sensors, indicate that the container is occupied.

The detector 10 may be provided with a fire suppressant device. The fire suppressant device may be disposed within the housing 16. The detector 10 may be configured to activate the fire suppressant device in response to detection of fire within the housing 16, e.g. through the detection of smoke within the housing 16.

The detector 10 may be provided with a positioning system (e.g. it could be fitted with a GPS tracker) to enable the location of the container 2 to be tracked. In this way, should it be determined that there is an occupant of a container 2, it would be possible to remotely determine where the occupant was located.

Although the invention has been described above with reference to one or more preferred embodiments, it will be appreciated that various changes or modifications may be made without departing from the scope of the invention as defined in the appended claims.

1. A detector for mounting to a container defining an internal space to determine occupancy of the container, the detector comprising:
a housing;
a mounting arrangement for mounting the housing to a container;
a sensor arrangement mounted to the housing, the sensor arrangement comprising a sensor configured to monitor the container and to generate a sensor output signal in response to a sensed container event, wherein the sensor is configured to detect container events in the form of vibration of a container; and
a control system comprising a processor configured to execute a machine learning algorithm trained to determine a class of the sensed container event to determine occupancy of the container from the sensor output signal,
wherein the machine learning algorithm is trained to determine and classify a person entering a container and/or a person leaving a container; and
wherein the control system is configured to provide an output of the determined occupancy of the container based on the sensed container event class determined by the machine learning algorithm.

2. A detector according to claim 1, wherein the processor is configured to communicate the determined occupancy of a container to an indicator, a display, or another device, the indicator, a display, or another device having a first state indicating that a container is occupied and a second state indicating that a container is unoccupied, wherein the output of the control system sets the state of the indicator based on the output of the machine learning algorithm.

3. A detector according to claim 1, comprising an indicator comprising a first state indicating that a container is occupied and a second state indicating that a container is unoccupied, wherein the output of the control system sets the state of the indicator based on the output of the machine learning algorithm, optionally wherein the indicator comprises an audible indicator and/or a visual indicator.

4. A detector according to claim 2, wherein the sensor arrangement is configured to determine an orientation of a container, in use, and wherein the control system is configured to reset the indicator, display or other device to the second state, e.g. from the first state, upon rotation of a container by at least a predetermined angle, optionally wherein the predetermined angle is approximately 90 degrees.

5. A detector according to claim 1, wherein the processor is configured to receive an update to the machine learning algorithm, and wherein the update is configured to train the machine learning algorithm to determine the occupancy of a new type or size of container.

6. A detector according to claim 1, wherein the machine learning algorithm has been trained using training data generated by a detector being mounted to a training container, optionally wherein the training data comprises a plurality of sensor output signals each generated in response to a sensed container event, and a class of container event corresponding to each sensor output signal.

7. A detector according to claim 6, wherein the machine learning algorithm is trained using training data generated by a detector mounted to any of a container adjacent to building air vents, a container in an enclosed space, a container in an open space and a container adjacent to heavy traffic.

8. A detector according to claim 1, wherein the machine learning algorithm is trained to determine and classify one or more of: different types of material being loaded into a container; material being removed from a container; material within a container being depressed; movement of a container, e.g. over a surface; rotation of a container; opening of a container lid or door; closing of a container lid or door; objects colliding with a container; and a person moving within a container.

9. A detector according to claim 1, comprising an indicator comprising a first state indicating that a container is occupied and a second state indicating that a container is unoccupied, wherein the control system is configured to activate the indicator for a predetermined period of time, e.g. 10 seconds, 30 seconds, or a minute, after a sensor output signal is received by the machine learning algorithm.

10. A detector according to claim 1, comprising a power storage unit disposed within the housing configured to provide power to the sensor arrangement, and wherein the power storage unit is mounted to the housing via an antivibration mounting arrangement.

11. A detector according to claim 1, wherein the housing is sealed so as to prevent the ingress of dust, moisture or debris, and wherein the sensor is disposed within the housing.

12. A detector according to claim 1, wherein the sensor comprises an accelerometer and/or a gyroscope.

13. A detector according to claim 1, wherein the mounting arrangement comprises at least one fastener configured and arranged to extend through an outer wall of a container, in use, in order to mount the detector to the container, optionally wherein the mounting arrangement comprises a mounting plate for positioning within a container such that a section of a container is positioned between the mounting plate and the housing, in use.

14. A detector according to claim 1, wherein the sensor arrangement comprises a temperature sensor configured to detect the temperature within a container, and wherein, when the temperature within the container exceeds a pre-determined value an output from the temperature sensor is compared with the output from the machine learning algorithm, optionally wherein the temperature sensor is configured to detect temperature outside of a container, and wherein, when the difference between the temperature inside a container and the temperature outside of a container exceeds a pre-determined value an output from the temperature sensor is compared with the output from the machine learning algorithm.

15. A detector according to claim 1, wherein the sensor arrangement comprises a humidity sensor configured to monitor humidity within a container, and wherein, when the humidity within a container exceeds a predetermined value, an output from the humidity sensor is compared with the output from the machine learning algorithm.

16. A detector according to claim 1, wherein the sensor arrangement comprises a further sensor configured to determine a concentration of carbon dioxide and/or volatile organic compounds within the internal space of the container, and wherein, when the concentration of carbon dioxide and/or volatile organic compounds exceeds a predetermined value, an output from the further sensor is compared with the output from the machine learning algorithm.

17. A container comprising:
a body defining an internal space; and
a detector mounted to the body and configured to determine the occupancy of the container,
wherein the detector comprises a housing, a mounting arrangement for mounting the housing to a container, a sensor arrangement mounted to the housing, the sensor arrangement comprising a sensor configured to monitor the container and to generate a sensor output signal in response to a sensed container event, wherein the sensor is configured to detect container events in the form of vibration of the container, and a control system comprising a processor configured to execute a machine learning algorithm trained to determine a class of the sensed container event for determining occupancy of the container from the sensor output signal, wherein the control system is configured to provide an output based on the sensed container event class determined by the machine learning algorithm, wherein the machine learning algorithm is trained to determine and classify one or more of a person entering a container and/or a person leaving a container,
wherein the container is a refuse container, a recycling container, or a shipping container.

18. A container according to claim 17, wherein the container is a trailer of a road vehicle.

19. A method of determining the occupancy of the container of claim 17, the method comprising:
monitoring the container with the sensor;
generating a sensor output signal in response to a sensed container event;
using a machine learning algorithm to determine a class of the sensed container event in order to determine the occupancy of the container; and
providing an output based on the occupancy of the container determined by the machine learning algorithm.

20. A method of generating training data for supervised machine learning, the method comprising:
mounting a detector according to claim 1 to a training container; and
generating training data by:
sensing a container event with the sensor so as to generate a sensor output signal; and
inputting into the control system the class of container event corresponding to the sensor output signal,
optionally wherein the processor is configured to generate training data by: receiving one or more sensor output signals from the sensor; and receiving the class of container event corresponding to the or each sensor output signal.
